(19) United States
(12) Patent Application Publication
(10) Pub. No.: US 2026/0212555 A1
(43) Pub. Date: Jul. 23, 2026

(54) SYSTEMS AND METHODS FOR PAGE HYDRATION

(71) Applicant: Netflix, Inc., Los Gatos, CA (US)

(72) Inventors: Jonathan Ebrahimian, Menlo Park, CA (US); David Gevorkyan, San Jose, CA (US); Stephen Matthew Chambers, Rowley, MA (US); Ashley Dietrich Featherston, Van Buren, MO (US)

(21) Appl. No.: 19/033,157

(22) Filed: Jan. 21, 2025

(51) Int. Cl. G06T 11/60; G06F 9/54

(52) U.S. Cl. CPC G06T 11/60; G06F 9/547

(57) ABSTRACT

The disclosed computer-implemented method may include receiving, by a server, a request from an application programming interface (API) to display a web page for a client device. Additionally, the method may include initiating, by the server, a page hydration process based on page structure data from the request. The method may also include determining, by the server, hydration data to display on the web page based on a contextual analysis of the page structure data. Furthermore, the method may also include collecting, by the server, the hydration data from a list of data services. Finally, the method may include completing, by the server, the page hydration process using the hydration data. Various other methods, systems, and computer-readable media are also disclosed.

### BACKGROUND

Online platforms and web-based services can provide data and functionality to users through web pages or web-based software applications. For example, a video streaming service can host videos that users can watch using personal computing devices with an application that accesses the service through a network connection. Some of these web-based services use web pages or application user interfaces with interactive elements that may take additional time to load. For services like video streaming that typically require transmitting large amounts of data, the additional load time can create latencies that are highly noticeable to users. Additionally, different amounts and types of data may be needed to hydrate a page, depending on the type of page and the user requesting the page.

Some web pages use methods like page hydration to reduce the initial latency by slowly adding the additional functionality and interactive elements as needed. For example, a streaming service may enable interactive elements for only the visible portions of a web page. As another example, a user interface may remain static until a user begins to interact with the web page, at which point the application can begin to load additional content. However, for more complex user interfaces or web pages, there may be many different types of data required for page hydration. These various types of data may be hosted in different locations and/or by different services, which need to be individually called to request the data. However, with the individual calls to different services, each service may be called multiple times to request data for different entities on the page. Additionally, with entities being processed independently, the resulting page hydration can result in redundant or overlapping information presented to the user, indicating a lack of coordination. As another example, similar information may be presented for multiple entities, or too much data may be presented to the user, causing information overload. Thus, better methods of hydrating web pages for online services are needed to reduce latency and improve user experience.

### SUMMARY

As will be described in greater detail below, the present disclosure describes systems and methods for page hydration. In one example, a computer-implemented method for page hydration may include receiving, by a server, a request from an application programming interface (API) to display a web page for a client device. The method may also include initiating, by the server, a page hydration process based on page structure data from the request. In addition, the method may include determining, by the server, hydration data to display on the web page based on a contextual analysis of the page structure data. Furthermore, the method may include collecting, by the server, the hydration data from a list of data services. Finally, the method may include completing, by the server, the page hydration process using the hydration data.

In one embodiment, the request may include an address of the web page, a type of web page, the page structure data collected by the API from a page construction layer, user data, and/or a mapping of an entity of the web page to a list of required hydration data. In this embodiment, the page structure data may include a layout of the web page, a description of sections of the web page, and/or a type of the entity of each section of the web page. Additionally, in this embodiment, initiating the page hydration process may include rendering the layout of the web page without the hydration data. In the above embodiments, the hydration data may include a video, an image, a text description, a descriptive tag, and/or metadata about the entity of the web page.

In one example, the contextual analysis of the page structure data may include an analysis based on a set of predefined rules, a context algorithm, and/or a machine learning model.

In some embodiments, determining the hydration data to display may include determining one or more types of hydration data for an entity of the web page and pruning a set of hydration data for the entity based on the contextual analysis of the page structure data. In these embodiments, pruning the set of hydration data for the entity based on the contextual analysis of the page structure data may include pruning the set of hydration data based on a location of the entity within the web page, a different entity of the web page, a type of section of the entity, a user history, and/or metadata about the entity. In these embodiments, pruning the set of hydration data may include pruning a unit of hydration data, a type of hydration data, and/or a parameter of hydration data.

In some examples, determining the hydration data to display may further include adjusting the hydration data to personalize the web page for a user of the client device.

In one embodiment, collecting the hydration data from the list of data services may include determining the list of data services based on a mapping of types of hydration data and data services that provide hydration data, requesting relevant hydration data from each data service, and receiving the relevant hydration data from each data service.

In one example, collecting the hydration data from the list of data services may further include performing batching of requests to the list of data services based on one or more performance metrics. In this example, completing the page hydration process may further include progressively hydrating the web page based on the batching of requests to the list of data services and/or a user action in the web page.

In some embodiments, completing the page hydration process may include hydrating each entity of the web page by inserting relevant hydration data for the entity based on the page structure data. In these embodiments, completing the page hydration process may include parallelized hydration of the hydration data for multiple entities of the web page.

In some examples, the computer-implemented method may further include receiving, from a downstream service, a request for at least a portion of the hydration data. In these examples, the computer-implemented method may further include sending the portion of the hydration data to the downstream service.

In addition, a corresponding system for page hydration may include several modules stored in memory, including a reception module that receives, by a server, a request from an API to display a web page for a client device. The system may also include an initiation module that initiates, by the server, a page hydration process based on page structure data from the request. In addition, the system may include a determination module that determines, by the server, hydration data to display on the web page based on a contextual analysis of the page structure data. Furthermore, the system may include a collection module that collects, by the server, the hydration data from a list of data services. Additionally, the system may include a completion module that completes, by the server, the page hydration process using the hydration data. Finally, the system may include one or more processors that execute the reception module, the initiation module, the determination module, the collection module, and the completion module.

In one embodiment, the initiation module may further perform a warming process to initiate the determination module and the collection module prior to initiating the page hydration process. In this embodiment, the collection module may collect initial hydration data during the warming process and cache the initial hydration data, and the completion module may complete the page hydration process by selecting from the cached initial hydration data, based on the determination module determining the hydration data to display, to hydrate the web page.

In some examples, the above-described method may be encoded as computer-readable instructions on a non-transitory computer-readable medium. For example, a computer-readable medium may include one or more computer-executable instructions that, when executed by at least one processor of a computing device, such as a server, may cause the computing device to receive a request from an API to display a web page for a client device. The instructions may also cause the computing device to initiate a page hydration process based on page structure data from the request. In addition, the instructions may cause the computing device to determine hydration data to display on the web page based on a contextual analysis of the page structure data. Furthermore, the instructions may cause the computing device to collect the hydration data from a list of data services. Finally, the instructions may cause the computing device to complete the page hydration process using the hydration data.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for page hydration.

FIG. 2 is a block diagram of an exemplary computing system for page hydration.

FIG. 3 is a block diagram of an exemplary web page structure prior to hydration and pruning.

FIG. 4 is a block diagram of an exemplary model for determining exemplary hydration data.

FIG. 5 is a block diagram of an exemplary architecture for interacting with exemplary data services.

FIG. 6 is a flow diagram of an exemplary web page request and hydration process.

FIG. 7 is a block diagram of an exemplary web page structure with associated hydration data and pruning.

FIG. 8 is a block diagram of an exemplary content distribution ecosystem.

FIG. 9 is a block diagram of an exemplary distribution infrastructure within the content distribution ecosystem shown in FIG. 8.

FIG. 10 is a block diagram of an exemplary content player within the content distribution ecosystem shown in FIG. 8.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to hydrating web pages for display to users of an online service. As will be explained in greater detail below, embodiments of the present disclosure may, by coordinating between types of data and between sections of a web page, account for the context of the web page's structure during page hydration. The disclosed systems and methods first detect a client device attempting to access a web page of an online service through an application programming interface (API). In some examples, the disclosed systems and methods may act as an intermediary between the API and backend services that provide data. For example, the systems and methods described herein may receive information about a user of the client device and the web page the user is attempting to access. In this example, the systems and methods described herein can use page structure information to begin rendering a static page.

The disclosed systems and methods then analyze the page structure data to determine context and to prune unwanted or redundant hydration data. For example, the systems and methods described herein can train a machine learning model to determine patterns of preferred hydration data based on a page layout. As another example, the systems and methods described herein can apply rules defined by an administrator of the online service to apply restrictions to the hydration data. In these examples, the disclosed systems and methods can then apply the analysis of the page layout to request the relevant hydration data from other services and/or to prune existing data. By selectively determining what hydration data to request, the systems and methods described herein can act as an optimizing query planner that uses high-level queries to assemble a response to the API as efficiently as possible. In addition, by unifying the logic and processes for various hydration data to avoid redundant computations or redundant requests, such as by batching requests, the disclosed systems and methods can potentially handle many different types of data simultaneously. Furthermore, the disclosed systems and methods can use the common data needed for hydration that is collected from various services to hydrate the web page as needed and/or to pass the data to a downstream service. For example, the disclosed systems and methods can hydrate the web page by section, such as by first hydrating only visible sections, and/or by parallel processes to precompute hydration data outside of the visible scope of the page, giving hydration services additional computational budget. In some examples, the disclosed systems and methods may warm the hydration process by initiating the hydration analysis while rendering the static skeleton of the web page. For example, the disclosed systems and methods can use basic user data to initiate the process of collecting some types of hydration data while additional analysis is performed to fine tune other types of hydration data.

The systems and methods described herein may improve the functioning of a computing device by analyzing and leveraging contextual page information to prune hydration data and to determine what to display. For example, the disclosed systems and methods can evaluate the data structure of the whole web page to select better hydration data based on where the data will be displayed and what the context of the display is, thereby creating a more cohesive and coordinated page. The systems and methods described herein can then streamline calls to other services and databases, such as services that check for user permissions or that provide interactive content, to simplify the requests and minimize the amount of data requested. By comprehensively budgeting time and resources for page hydration as a whole on the server side, the disclosed systems and methods can provide a cohesive hydration experience while decreasing the latency for web page rendering for clients. In addition, these systems and methods may improve the fields of streaming services and web design by optimizing hydration data for more cohesive design. For example, by tailoring hydration data to specific users, the disclosed systems and methods improve the personalization of page content. As another example, by coordinating between backend services to avoid separate individual calls to each service, the systems and methods described herein improve the efficiency of collecting relevant hydration data. Thus, the disclosed systems and methods may improve over traditional methods of web page hydration that can be slow and clunky without context.

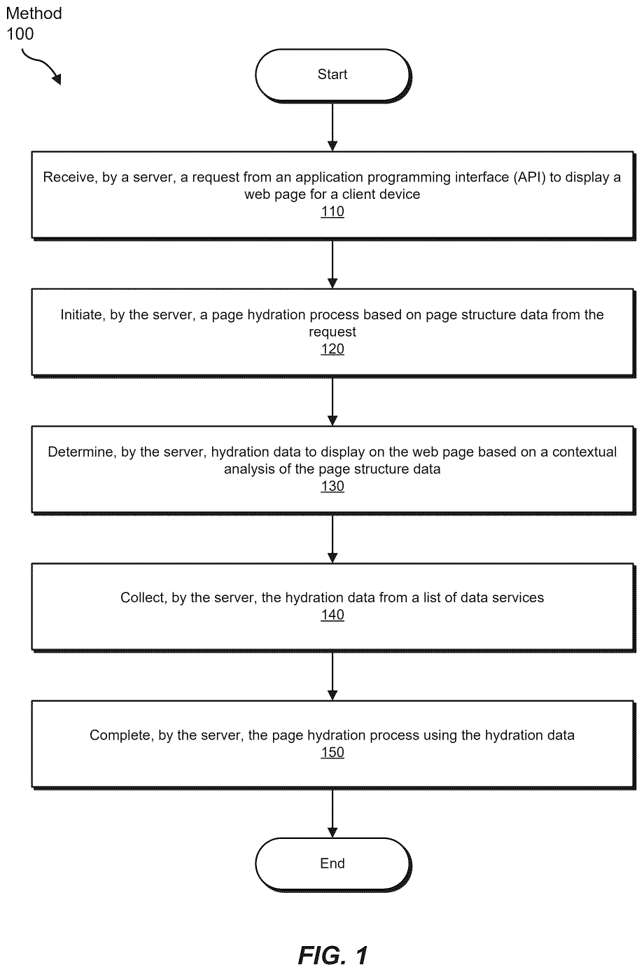

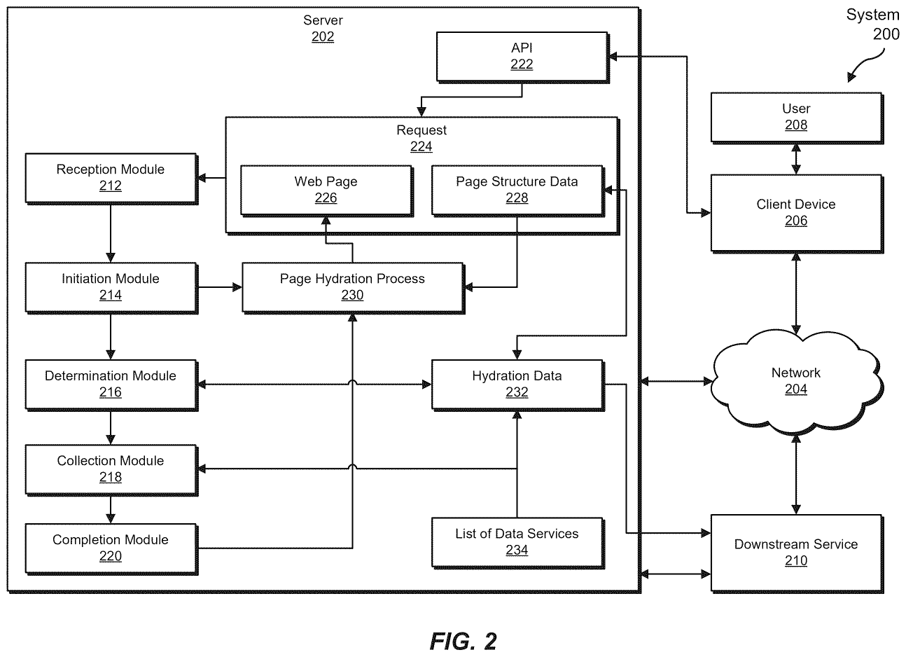

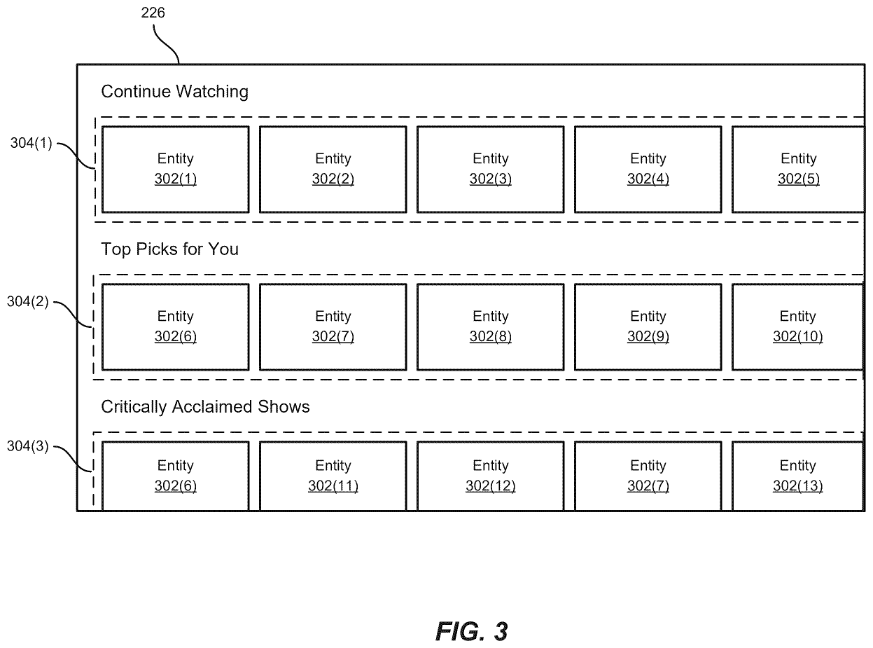

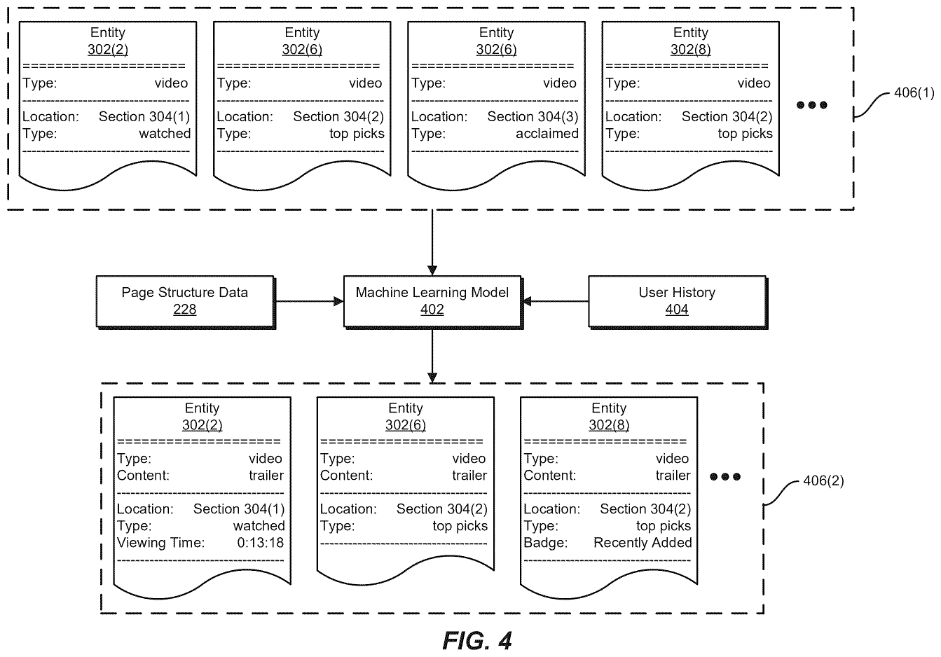

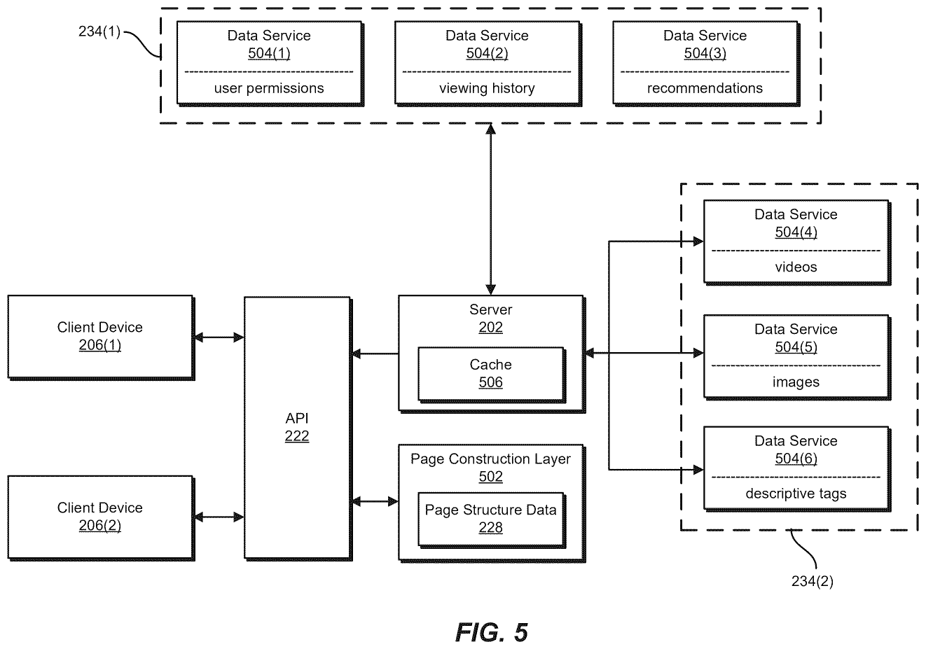

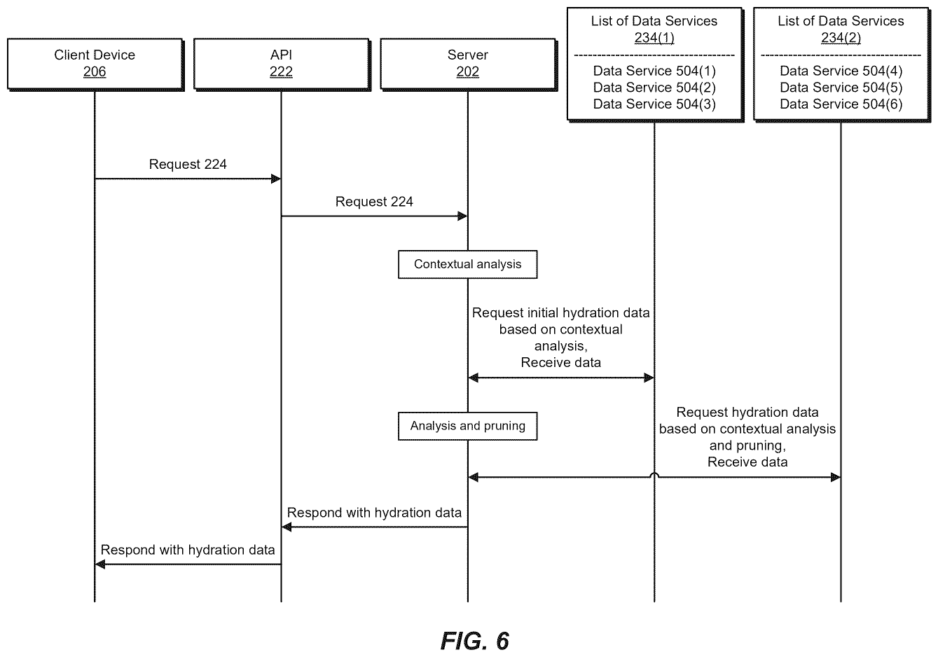

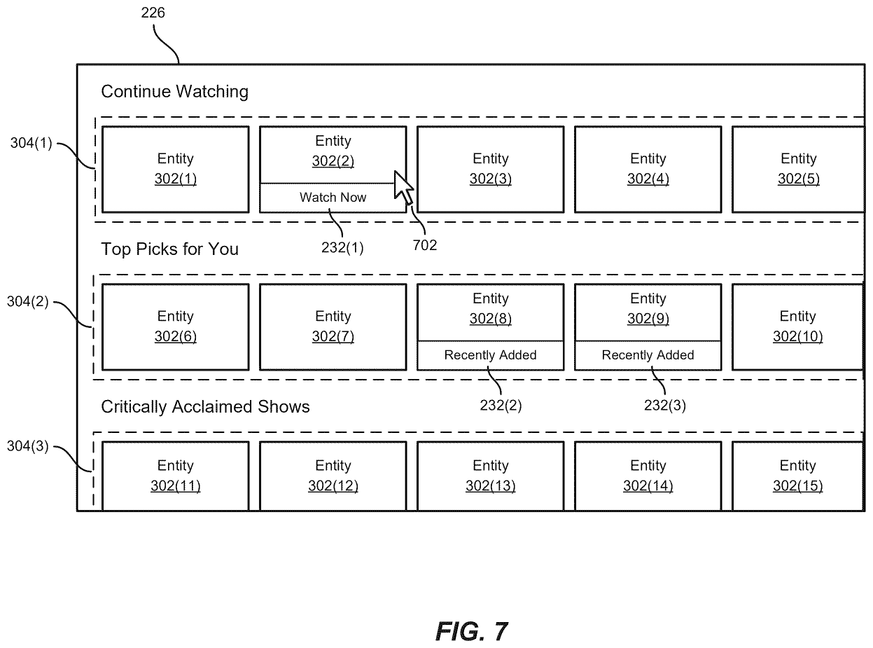

Thereafter, the description will provide, with reference to FIG. 1, detailed descriptions of computer-implemented methods for page hydration. Detailed descriptions of a corresponding exemplary computing system will be provided in connection with FIG. 2. Detailed descriptions of an exemplary web page structure prior to hydration and pruning will be provided in connection with FIG. 3. In addition, detailed descriptions of an exemplary model for determining exemplary hydration data will be provided in connection with FIG. 4. Detailed descriptions of an exemplary architecture for interacting with exemplary data services will be provided in connection with FIG. 5. Furthermore, detailed descriptions of an exemplary web page request and hydration process will be provided in connection with FIG. 6. Additionally, detailed descriptions of an exemplary web page structure with associated hydration data and pruning will be provided in connection with FIG. 7.

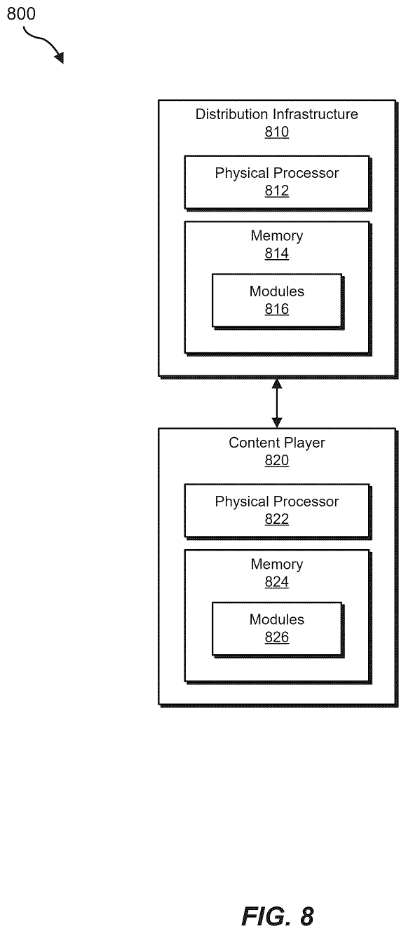

Because many of the embodiments described herein may be used with substantially any type of computing network, including distributed networks designed to provide video content to a worldwide audience, various computer network and video distribution systems will initially be described with reference to FIGS. 8-10. These figures will introduce the various networks and distribution methods used to provision video content to users.

FIG. 1 is a flow diagram of an exemplary computer-implemented method 100 for page hydration. The steps shown in FIG. 1 may be performed by any suitable computer-executable code and/or computing system, including the systems illustrated in FIGS. 8-10, server 202 in FIG. 2, or a combination of one or more of the same. In one example, each of the steps shown in FIG. 1 may represent an algorithm whose structure includes and/or is represented by multiple sub-steps, examples of which will be provided in greater detail below. In some examples, all of the steps and sub-steps represented in FIG. 1 may be performed by one device (e.g., either a server or a client computing device). Alternatively, the steps and/or substeps represented in FIG. 1 may be performed across multiples devices (e.g., some of steps and/or sub-steps may be performed by a server and other steps and/or sub-steps may be performed by a client computing device).

As illustrated in FIG. 1, at step 110, one or more of the systems described herein may receive, by a server, a request from an API to display a web page for a client device. For example, FIG. 2 is a block diagram of an exemplary system 200 for page hydration. As illustrated in FIG. 2, a reception module 212 may, as part of a server 202, receive a request 224 from an API 222 to display a web page 226 for a client device 206.

In some embodiments, server 202 may generally represent a device capable of processing user and/or client device requests to provide hydration data of web pages for an online service, such as a content hosting platform. Server 202 may alternatively generally represent any type or form of server that is capable of storing and/or managing content and user data, such as videos for a video hosting platform. Examples of a server include, without limitation, security servers, application servers, web servers, storage servers, streaming servers, and/or database servers configured to run certain software applications and/or to provide various security, web, storage, streaming, and/or database services. Additionally, server 202 may include distribution infrastructure 810 and/or various other components of FIGS. 8-10.

Although illustrated as part of server 202 in FIG. 2, some or all of the modules described herein may alternatively be executed by a separate server or any other suitable computing device. For example, server 202 may represent a separate device for managing API requests for an online service or, alternatively, may represent part of system 200 for providing the online service as a whole. As another example, server 202 may represent an endpoint device or multiple endpoint devices that service client devices. For example, system 200 may include multiple servers and/or computing devices that include server 202, downstream service 210, databases hosting a variety of data and backend services, and/or any other suitable device or combination of devices.

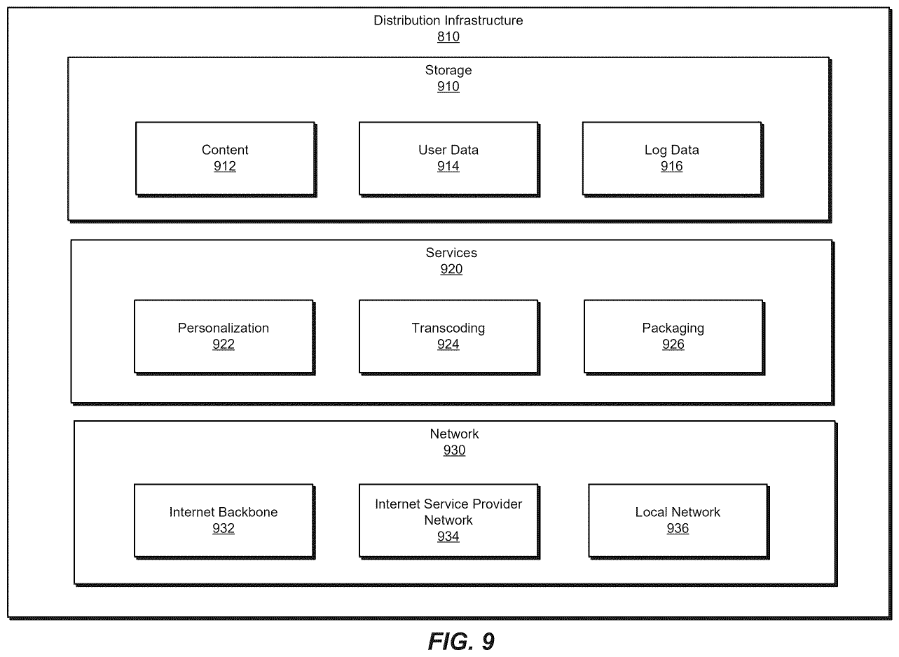

In the above embodiments, server 202 may be directly in communication with other servers and/or in communication with other computing devices, such as a client device 206 and/or a downstream service 210, via a network, such as a network 204 of FIG. 2. In some examples, the term “network” may refer to any medium or architecture capable of facilitating communication or data transfer. Examples of networks include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), network 930 of FIG. 9, or any other suitable network. For example, network 204 may facilitate data transfer between server 202 and client device 206 using wireless or wired connections and between server 202 and downstream service 210. In other examples, downstream service 210 may be hosted on server 202 or another device of system 200.

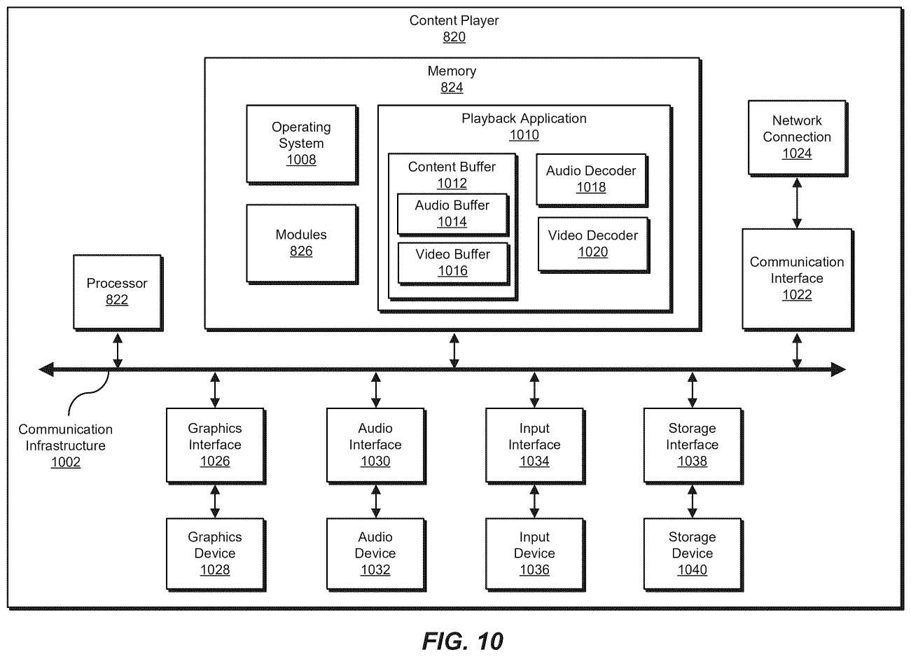

In some examples, client device 206 may generally represent any type or form of computing device capable of running computing software and applications. As used herein, the term “application” generally refers to a software program designed to perform specific functions or tasks and capable of being installed, deployed, executed, and/or otherwise implemented on a computing system. Examples of applications may include, without limitation, playback application 1010 of FIG. 10, productivity software, enterprise software, entertainment software, security applications, cloud-based applications, web applications, mobile applications, content access software, simulation software, integrated software, application packages, application suites, variations or combinations of one or more of the same, and/or any other suitable software application. Examples of client devices may include, without limitation, laptops, tablets, desktops, servers, cellular phones, Personal Digital Assistants (PDAs), multimedia players, embedded systems, wearable devices (e.g., smart watches, smart glasses, etc.), gaming consoles, combinations of one or more of the same, or any other suitable computing device. Additionally, client devices may include content player 820 in FIGS. 8 and 10 and/or various other components of FIGS. 8-10.

The systems described herein may perform step 110 in a variety of ways. As used herein, the term “online service” generally refers to a resource or service that is provided over a network, such as the Internet. Examples of online services may include, without limitation, Software as a Service (SaaS), Platform as a Service (PaaS), Infrastructure as a Service (IaaS), digital media streaming, file hosting services, electronic commerce services, variations or combinations of one or more of the same, distribution infrastructure 810 of FIGS. 8-9, and/or any other suitable web-based service. As used herein, the term “application programming interface” generally refers to a software interface that facilitates interactions between computing devices, such as between server 202 and client device 206. As used herein, the term “web page” generally refers to a document or displayed data that can be accessed through a network, such as network 204.

In some embodiments, request 224 includes an address of web page 226, a type of web page 226, page structure data 228 collected by API 222 from a page construction layer, user data, and/or a mapping of an entity of web page 226 to a list of required hydration data. As used herein, the term “page construction layer” generally refers to a service that enables the build of a skeleton or a framework of web pages and/or that provides the instructions for web pages. In some examples, the term “entity” refers to a data structure or content within a web page, such as an interactive video in a streaming service. In some examples, the term “hydration” refers to a method for converting a static web page, which is stored and displayed as is, into a dynamic web page that is constructed at run time, such as by including event handlers and interactive elements.

As illustrated in FIG. 5, a client device 206(1) and/or a client device 206(2) can connect to API 222 to request web page 226 of FIG. 2. In this example, client devices 206(1)-(2) can have client-side API functionality that interfaces with server-side API functionality to send and receive data. In this example, API 222 can then make a call to a page construction layer 502 to request page structure data 228 for web page 226 of FIG. 2. As used herein, the term “call” generally refers to a request for services or to process a routine or function. In the example of FIG. 5, page construction layer 502 then returns page structure data 228 to API 222, which then sends page structure data 228 to server 202 with request 224 of FIG. 2.

Returning to FIG. 1, at step 120, one or more of the systems described herein may initiate, by the server, a page hydration process based on page structure data from the request. For example, an initiation module 214 may, as part of server 202 in FIG. 2, initiate a page hydration process 230 based on page structure data 228 from request 224.

The systems described herein may perform step 120 in a variety of ways. In some examples, page structure data 228 may include a layout of web page 226, a description of sections of web page 226, and/or a type of each entity of each section of web page 226. In the example of a streaming service, page structure data 228 can include a list of identifiers of videos to display, as separate entities, sections of web page 226 and the types of videos populating each section, and a general layout of where the sections are located within web page 226. In this example, the identifiers of videos can provide metadata about the entities, such as an ability to retrieve titles and introductory images, without including an ability to play the videos. As used herein, the term “metadata” generally refers to data that describes or provides additional information about other data, files, or the structure of files. In the example of FIG. 5, API 222 may pass request 224 to server 202 along with page structure data 228 and basic information about web page 226. In some examples, initiation module 214 can initiate page hydration process 230 by rendering the layout of web page 226 without hydration data 232. As used herein, the term “render” generally refers to a process of generating graphics for viewable content. By initiating page hydration process 230 using the initial layout, server 202 can begin to collect and load data that may be in the final page rendering.

In the example of FIG. 3, web page 226 includes entities 302(1)-(13) divided into sections 304(1)-(3), with additional content that may be viewed by scrolling. In this example, each of entities 302(1)-(13) can include an initial display of a title and an image representing video content that is not yet interactive. Additionally, the initial skeleton of web page 226 may have redundant information, such as including entities 302(6)-(7) in both section 304(2) and section 304(3). In some examples, server 202 may not want to display the redundant information and may remove or filter the information prior to displaying web page 226 for a user 208 of client device 206.

Returning to FIG. 1, at step 130, one or more of the systems described herein may determine, by the server, hydration data to display on the web page based on a contextual analysis of the page structure data. For example, a determination module 216 may, as part of server 202 in FIG. 2, determine hydration data 232 to display on web page 226 based on a contextual analysis of page structure data 228.

The systems described herein may perform step 130 in a variety of ways. In one embodiment, hydration data 232 can include a video, an image, a text description, a descriptive tag, and/or metadata about an entity of web page 226. In the example of FIG. 5, for a streaming service, hydration data 232 can be obtained from data services 504(1)-(6) that include data about users, such as user permissions, viewing history, and recommendations of videos.

In one embodiment, the contextual analysis of page structure data 228 includes an analysis based on a set of predefined rules, a context algorithm, and/or a machine learning model. As used herein, the term “machine learning model” generally refers to a computational algorithm that may learn from data in order to make predictions. Examples of machine learning models may include, without limitation, support vector machines, neural networks, clustering models, decision trees, classifiers, variations or combinations of one or more of the same, and/or any other suitable model. In some embodiments, determination module 216 can determine hydration data 232 to display by determining one or more types of hydration data for entities of web page 226 and pruning a set of hydration data for the entities based on the contextual analysis of page structure data 228. As used herein, the term “pruning” generally refers to a process of removing extraneous information and/or reducing a size or a complexity of data.

In the example of FIG. 4, a machine learning model 402 may learn from historical data and/or rules, such as the set of predefined rules or the context algorithm, to prune a set of hydration data 406(1) given page structure data 228 and a user history 404. In this example, machine learning model 402 can prune redundant information, such as two instances of entity 302(6), while adding relevant hydration data, such as viewing time for a watched video of entity 302(2) and a descriptive badge for entity 302(8), to create a set of hydration data 406(2). As another example, an administrator of the streaming service can define a set of rules to select hydration data, such as by specifying the pruning of redundant data or enforcing visual themes for web page design. Similarly, the context algorithm can use parameters for web page design to ensure a more cohesive appearance depending on the type of sections or other context information.

In one embodiment, pruning a set of hydration data for the entity based on the contextual analysis of page structure data 228 can include pruning the set of hydration data based on a location of the entity within web page 226, a different entity of web page 226, a type of section of the entity, a user history, and/or metadata about the entity. As described in the example of FIG. 3, determination module 216 can prune one instance of each of entities 302(6)-(7) based on overall page coordination, such as a rule to only present unique entities in web page 226. In the example of a streaming service, determination module 216 can prune hydration data 232 based on knowing whether web page 226 is a home page, a search page, a genre page, and/or a different type of page. Similarly, determination module 216 can prune hydration data 232 based on the location and/or sections of entities, such as video links, within web page 226. In the example of FIG. 3, determination module 216 may prioritize section 304(2) that is tailored to user 208 over section 304(3), which is a general popular list, when selecting which section to display entities 302(6)-(7).

In some embodiments, determination module 216 can prune the set of hydration data by pruning a unit of hydration data, a type of hydration data, and/or a parameter of hydration data. In the example of a streaming service, a parameter of hydration data can include a badge, which acts as a description of a video in comparison to other videos. For example, entity 302(8) of FIG. 4 includes a badge describing the video as recently added to the streaming service. In some embodiments, determination module 216 can determine what types of hydration data is relevant for each entity in web page 226 in consideration of other entities of web page 226, such as entities within the same section. For example, determination module 216 can remove all badges that describe videos as being rated in the top ten of the streaming service when those entities are in section 304(3) of FIG. 3, which indicates acclaimed shows that are likely to include all or most of the top titles. Thus, determination module 216 can avoid displaying section 304(3) with the same repetitive badge on each title. In this example, determination module 216 determines the context of section 304(3) to determine certain types of hydration data should be pruned.

In one embodiment, determination module 216 can determine hydration data 232 to display by further adjusting hydration data 232 to personalize web page 226 for user 208. In the example of FIG. 4, machine learning model 402 can use user history 404 to further select appropriate hydration data 232 based on past user actions or user permissions that can affect the content of web page 226. In one streaming service example, determination module 216 can determine what evidence to provide user 208 for recommended shows, such as by tagging titles with “top ten” or “recently added” badges. In the example of FIG. 7, badges describing entities 302(8)-(9) as recently added can provide additional information to user 208 for why these titles were recommended. In other examples, determination module 216 can include descriptions such as synopses of titles or information about related titles that user 208 has watched as additional context for recommendations. In these examples, determination module 216 can also collect data to determine the order to display entities within each section, such as a ranked order of recommendations for user 208. Furthermore, determination module 216 can collect or generate explanations to user 208 about how recommendations are presented in web page 226.

As another example, a top ten section for movie titles may include interactive hydration data that plays short trailers for each entity. In this example, determination module 216 may select hydration data 232 that includes less scary trailers for horror movies in comparison to a section specifically for horror movie titles. In a design example, determination module 216 can evaluate images displayed across a section of web page 226 to ensure more contrasting images for different entities or to color coordinate between entities. As another example, determination module 216 can determine the context of a section is for shows with award-winning actresses and, subsequently, can select hydration data 232 to include images highlighting these actresses instead of images of other actors or actresses.

Returning to FIG. 1, at step 140, one or more of the systems described herein may collect, by the server, the hydration data from a list of data services. For example, a collection module 218 may, as part of server 202 in FIG. 2, collect hydration data 232 from a list of data services 234.

The systems described herein may perform step 140 in a variety of ways. In some examples, collection module 218 collects hydration data 232 from list of data services 234 by determining what data services are in list of data services 234 based on a mapping of types of hydration data and data services that provide hydration data, requesting relevant hydration data from each data service, and receiving the relevant hydration data from each data service. In these examples, data services can include backend services that store, process, and/or analyze data. Additionally, in these examples, collection module 218 can collect hydration data 232 from list of data services 234 by further performing batching of requests to list of data services 234 based on one or more performance metrics. As used herein, the term “batching” generally refers to a process of grouping similar tasks to perform them together. For example, with limited time to hydrate web page 226, collection module 218 can combine all calls to each data service into a single call rather than repeatedly calling the data service.

In the example of FIG. 5, a list of data services 234(1) can include remote data services 504(1)-(3), and a list of data services 234(2) can include local data services 504(4)-(6). In this example, calls to list of data services 234(1) can be more costly than calls to list of data services 234(2). With limited time and resources, collection module 218 can batch calls to list of data services 234(1) to only call data services 504(1)-(3) once while still enabling flexibility of separate calls to data services 504(4)-(6). In other examples, collection module 218 can perform batching for all requests for hydration data in order to streamline data collection.

As illustrated in FIG. 6, server 202 can perform a contextual analysis and request data from list of data services 234(1) in one batch. Subsequently, server 202 can perform additional analysis and pruning to determine what data to further request from list of data services 234(2), which may also be batched. The collected data from both list of data services 234(1) and 234(2) can be assembled into a comprehensive package that can be used by server 202 and/or API 222 to determine how to hydrate web page 226. In addition, this comprehensive packaging of data can be passed back to client device 206 to fully hydrate web page 226.

Returning to FIG. 1, at step 150, one or more of the systems described herein may complete, by the server, the page hydration process using the hydration data. For example, a completion module 220 may, as part of server 202 in FIG. 2, complete page hydration process 230 using hydration data 232.

The systems described herein may perform step 150 in a variety of ways. In some examples, completion module 220 can complete page hydration process 230 by progressively hydrating web page 226 based on the batching of requests to list of data services 234 and/or based on a user action in web page 226, which can trigger various interactive elements. In some examples, completion module 220 completes page hydration process 230 by hydrating each entity of web page 226 by inserting relevant hydration data for the entity based on page structure data 228. Additionally or alternatively, completion module 220 completes page hydration process 230 by parallelized hydration of hydration data 232 for multiple entities of web page 226. For example, server 202 can use a single endpoint to request images from data service 504(5) of FIG. 5 and hydrate all images of web page 226 using the collected images. In contrast, server 202 can perform batching by sections of web page 226 and parallelize hydration of images across each section at a time.

In the example of FIG. 7, completion module 220 can first batch calls for hydration data for section 304(1), including hydration data 232(1) that provides an option to watch entity 302(2). In this example, user 208 has moved a cursor in web page 226 as part of a user action 702 to hover over entity 302(2), and completion module 220 can hydrate entity 302(2) with hydration data 232(1) as a response. Additionally, completion module 220 can then hydrate section 304(2) to include badges as hydration data 232(2)-(3), describing entities 302(8)-(9) as recently added. In this example, completion module 220 may defer hydration of section 304(3) until user 208 has fully scrolled down in web page 226 to reveal the entirety of section 304(3). Additionally, based on previous pruning by determination module 216, web page 226 may no longer include duplicated entities 302(6)-(7) and may, instead, add entities 302(14)-(15). In the above examples, completion module 220 may further batch hydration of sections to comply with a predetermined allowance for latency.

In some embodiments, the above described methods may further include receiving, from downstream service 210, a request for at least a portion of hydration data 232. In these embodiments, the methods may include sending the portion of hydration data 232 to downstream service 210. For example, downstream service 210 may represent a different local or remote backend service that provides further functionality to client device 206 and/or may represent a different service on client device 206. In other examples, downstream service 210 may represent data services, such as data services 504(1)-(6) of FIG. 5, that request information about other types of data, and server 202 can provide the contextual information to those data services.

In one embodiment, initiation module 214 can further perform a warming process to initiate determination module 216 and collection module 218 prior to initiating page hydration process 230. As used herein, the term “warming” generally refers to a method of initializing functions to begin prior to actual startup. In the example of a streaming service, the warming process can include requesting video data prior to actively constructing web page 226 using layout information. In this embodiment, collection module 218 can collect initial hydration data during the warming process and cache the initial hydration data. For example, while collection module 218 collects initial hydration data from remote data services that may take longer, determination module 216 can begin the context analysis in parallel to determine other hydration data to collect. In this embodiment, completion module 220 can subsequently complete page hydration process 230 by selecting from the cached initial hydration data, based on determination module 216 determining hydration data 232, to hydrate web page 226. In the example of FIG. 6, initial hydration data collected from list of services 234(1) can include information on what titles can be played by user 208 based on user location and permissions, without knowing additional details. For example, with only data about the location of client device 206 and a subscription level of user 208, collection module 218 can begin to collect data on a set of titles that are available in that geographic region to user 208. In this example, the initial hydration data can also provide context to be used by server 202 to determine hydration data 232 during analysis and pruning. In the example of FIG. 5, server 202 may cache the initial hydration data in a cache 506, which may represent a local temporary storage. In other examples, cache 506 may represent a remote database or other device used for temporary storage.

As explained above in connection with method 100 in FIG. 1, the disclosed systems and methods, by determine how to request hydration data through analyses of web page structure, can support flexible collection and presentation of web-based data that accounts for the context of a web page. Specifically, the disclosed systems and methods first collect data about the page structure of a web page that is to be hydrated. For example, the disclosed systems and methods can obtain a skeletal layout of sections of a page, with descriptions of data to be included in each section. By initiating the page construction using the initial layout information, the systems and methods described herein can load some of the data that may be used for the web page without waiting for all of the hydration process to complete, thereby reducing the latency of page construction. Additionally, by analyzing the page structure to determine the context of sections as well as the overall web page, the systems and methods described herein can selectively choose and prune what types of data to request for hydration. Rather than depending on individual backend data services to determine what data to present, the disclosed systems and methods can perform that determination in a comprehensive way to account for all types of data.

The disclosed systems and methods then perform calls to the backend data services to request the specific types of data. For example, the systems and methods described herein may perform batch calls to each service to reduce the number of total calls required. The disclosed systems and methods may also perform batching by sections of the page, rather than by types of data. The collective data can then be passed to a client device and used to hydrate the web page. In other words, by hydrating portions of the web page in parallel, the disclosed systems and methods can show progressively richer content to a user. Thus, the systems and methods described herein may improve over traditional methods of hydrating a variety of web page data for users.

Content that is created or modified using the methods described herein may be used and/or distributed in a variety of ways and/or by a variety of systems. Such systems may include content distribution ecosystems, as shown in FIGS. 8-10.

FIG. 8 is a block diagram of a content distribution ecosystem 800 that includes a distribution infrastructure 810 in communication with a content player 820. In some embodiments, distribution infrastructure 810 may be configured to encode data and to transfer the encoded data to content player 820 via data packets. Content player 820 may be configured to receive the encoded data via distribution infrastructure 810 and to decode the data for playback to a user. The data provided by distribution infrastructure 810 may include audio, video, text, images, animations, interactive content, haptic data, virtual or augmented reality data, location data, gaming data, or any other type of data that may be provided via streaming.

Distribution infrastructure 810 generally represents any services, hardware, software, or other infrastructure components configured to deliver content to end users. For example, distribution infrastructure 810 may include content aggregation systems, media transcoding and packaging services, network components (e.g., network adapters), and/or a variety of other types of hardware and software. Distribution infrastructure 810 may be implemented as a highly complex distribution system, a single media server or device, or anything in between. In some examples, regardless of size or complexity, distribution infrastructure 810 may include at least one physical processor 812 and at least one memory device 814. One or more modules 816 may be stored or loaded into memory 814 to enable adaptive streaming, as discussed herein.

Content player 820 generally represents any type or form of device or system capable of playing audio and/or video content that has been provided over distribution infrastructure 810. Examples of content player 820 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 810, content player 820 may include a physical processor 822, memory 824, and one or more modules 826. Some or all of the adaptive streaming processes described herein may be performed or enabled by modules 826, and in some examples, modules 816 of distribution infrastructure 810 may coordinate with modules 826 of content player 820 to provide adaptive streaming of multimedia content.

In certain embodiments, one or more of modules 816 and/or 826 in FIG. 8 may represent one or more software applications or programs that, when executed by a computing device, may cause the computing device to perform one or more tasks. For example, and as will be described in greater detail below, one or more of modules 816 and 826 may represent modules stored and configured to run on one or more general-purpose computing devices. One or more of modules 816 and 826 in FIG. 8 may also represent all or portions of one or more special-purpose computers configured to perform one or more tasks.

Physical processors 812 and 822 generally represent any type or form of hardware-implemented processing unit capable of interpreting and/or executing computer-readable instructions. In one example, physical processors 812 and 822 may access and/or modify one or more of modules 816 and 826, respectively. Additionally or alternatively, physical processors 812 and 822 may execute one or more of modules 816 and 826 to facilitate adaptive streaming of multimedia content. Examples of physical processors 812 and 822 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 814 and 824 generally represent any type or form of volatile or non-volatile storage device or medium capable of storing data and/or computer-readable instructions. In one example, memory 814 and/or 824 may store, load, and/or maintain one or more of modules 816 and 826. Examples of memory 814 and/or 824 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 9 is a block diagram of exemplary components of content distribution infrastructure 810 according to certain embodiments. Distribution infrastructure 810 may include storage 910, services 920, and a network 930. Storage 910 generally represents any device, set of devices, and/or systems capable of storing content for delivery to end users. Storage 910 may include a central repository with devices capable of storing terabytes or petabytes of data and/or may include distributed storage systems (e.g., appliances that mirror or cache content at Internet interconnect locations to provide faster access to the mirrored content within certain regions). Storage 910 may also be configured in any other suitable manner.

As shown, storage 910 may store, among other items, content 912, user data 914, and/or log data 916. Content 912 may include television shows, movies, video games, user-generated content, and/or any other suitable type or form of content. User data 914 may include personally identifiable information (PII), payment information, preference settings, language and accessibility settings, and/or any other information associated with a particular user or content player. Log data 916 may include viewing history information, network throughput information, and/or any other metrics associated with a user's connection to or interactions with distribution infrastructure 810.

Services 920 may include personalization services 922, transcoding services 924, and/or packaging services 926. Personalization services 922 may personalize recommendations, content streams, and/or other aspects of a user's experience with distribution infrastructure 810. Encoding services, such as transcoding services 924, may compress media at different bitrates which may enable real-time switching between different encodings. Packaging services 926 may package encoded video before deploying it to a delivery network, such as network 930, for streaming.

Network 930 generally represents any medium or architecture capable of facilitating communication or data transfer. Network 930 may facilitate communication or data transfer via transport protocols using wireless and/or wired connections. Examples of network 930 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 9, network 930 may include an Internet backbone 932, an internet service provider 934, and/or a local network 936.

FIG. 10 is a block diagram of an exemplary implementation of content player 820 of FIG. 8. Content player 820 generally represents any type or form of computing device capable of reading computer-executable instructions. Content player 820 may include, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 10, in addition to processor 822 and memory 824, content player 820 may include a communication infrastructure 1002 and a communication interface 1022 coupled to a network connection 1024. Content player 820 may also include a graphics interface 1026 coupled to a graphics device 1028, an audio interface 1030 coupled to an audio device 1032, an input interface 1034 coupled to an input device 1036, and a storage interface 1038 coupled to a storage device 1040.

Communication infrastructure 1002 generally represents any type or form of infrastructure capable of facilitating communication between one or more components of a computing device. Examples of communication infrastructure 1002 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 824 generally represents any type or form of volatile or non-volatile storage device or medium capable of storing data and/or other computer-readable instructions. In some examples, memory 824 may store and/or load an operating system 1008 for execution by processor 822. In one example, operating system 1008 may include and/or represent software that manages computer hardware and software resources and/or provides common services to computer programs and/or applications on content player 820.

Operating system 1008 may perform various system management functions, such as managing hardware components (e.g., graphics interface 1026, audio interface 1030, input interface 1034, and/or storage interface 1038). Operating system 1008 may also process memory management models for playback application 1010. The modules of playback application 1010 may include, for example, a content buffer 1012, an audio decoder 1018, and a video decoder 1020.

Playback application 1010 may be configured to retrieve digital content via communication interface 1022 and play the digital content through graphics interface 1026. A video decoder 1020 may read units of video data from audio buffer 1014 and/or video buffer 1016 and may output the units of video data in a sequence of video frames corresponding in duration to the fixed span of playback time. Reading a unit of video data from video buffer 1016 may effectively de-queue the unit of video data from video buffer 1016. The sequence of video frames may then be rendered by graphics interface 1026 and transmitted to graphics device 1028 to be displayed to a user.

In situations where the bandwidth of distribution infrastructure 810 is limited and/or variable, playback application 1010 may download and buffer consecutive portions of video data and/or audio data from video encodings with different bit rates based on a variety of factors (e.g., scene complexity, audio complexity, network bandwidth, device capabilities, etc.). In some embodiments, video playback quality may be prioritized over audio playback quality. Audio playback and video playback quality may also be balanced with each other, and in some embodiments audio playback quality may be prioritized over video playback quality.

Content player 820 may also include a storage device 1040 coupled to communication infrastructure 1002 via a storage interface 1038. Storage device 1040 generally represent any type or form of storage device or medium capable of storing data and/or other computer-readable instructions. For example, storage device 1040 may be a magnetic disk drive, a solid-state drive, an optical disk drive, a flash drive, or the like. Storage interface 1038 generally represents any type or form of interface or device for transferring data between storage device 1040 and other components of content player 820.

Many other devices or subsystems may be included in or connected to content player 820. Conversely, one or more of the components and devices illustrated in FIG. 10 need not be present to practice the embodiments described and/or illustrated herein. The devices and subsystems referenced above may also be interconnected in different ways from that shown in FIG. 10. Content player 820 may also employ any number of software, firmware, and/or hardware configurations.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive a request for a web page to be transformed, transform the request to begin page construction, output a result of the transformation to determine hydration data for the web page, use the result of the transformation to collect the hydration data, and store the result of the transformation to hydrate the web page for a client device. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, by a server, a request from an application programming interface (API) to display a web page for a client device;
initiating, by the server, a page hydration process based on page structure data from the request;
determining, by the server, hydration data to display on the web page based on a contextual analysis of the page structure data;
collecting, by the server, the hydration data from a list of data services; and
completing, by the server, the page hydration process using the hydration data.

2. The method of claim 1, wherein the request comprises at least one of:
an address of the web page;
a type of web page;
the page structure data collected by the API from a page construction layer;
user data; or
a mapping of an entity of the web page to a list of required hydration data.

3. The method of claim 2, wherein the page structure data comprises at least one of:
a layout of the web page;
a description of sections of the web page; or
a type of the entity of each section of the web page.

4. The method of claim 3, wherein initiating the page hydration process comprises rendering the layout of the web page without the hydration data.

5. The method of claim 2, wherein the hydration data comprises at least one of:
a video;
an image;
a text description;
a descriptive tag; or
metadata about the entity of the web page.

6. The method of claim 1, wherein the contextual analysis of the page structure data comprises an analysis based on at least one of:
a set of predefined rules;
a context algorithm; or
a machine learning model.

7. The method of claim 1, wherein determining the hydration data to display comprises:
determining at least one type of hydration data for an entity of the web page; and
pruning a set of hydration data for the entity based on the contextual analysis of the page structure data.

8. The method of claim 7, wherein pruning the set of hydration data for the entity based on the contextual analysis of the page structure data comprises pruning the set of hydration data based on at least one of:
a location of the entity within the web page;
a different entity of the web page;
a type of section of the entity;
a user history; or
metadata about the entity.

9. The method of claim 7, wherein pruning the set of hydration data comprises pruning at least one of:
a unit of hydration data;
a type of hydration data; or
a parameter of hydration data.

10. The method of claim 1, wherein determining the hydration data to display further comprises adjusting the hydration data to personalize the web page for a user of the client device.

11. The method of claim 1, wherein collecting the hydration data from the list of data services comprises:
determining the list of data services based on a mapping of types of hydration data and data services that provide hydration data;
requesting relevant hydration data from each data service; and
receiving the relevant hydration data from each data service.

12. The method of claim 11, wherein collecting the hydration data from the list of data services further comprises performing batching of requests to the list of data services based on at least one performance metric.

13. The method of claim 12, wherein completing the page hydration process further comprises progressively hydrating the web page based on at least one of:
the batching of requests to the list of data services; or
a user action in the web page.

14. The method of claim 1, wherein completing the page hydration process comprises hydrating each entity of the web page by inserting relevant hydration data for the entity based on the page structure data.

15. The method of claim 14, wherein completing the page hydration process comprises parallelized hydration of the hydration data for multiple entities of the web page.

16. The method of claim 1, further comprising:
receiving, from a downstream service, a request for at least a portion of the hydration data; and
sending the portion of the hydration data to the downstream service.

17. A system comprising:
a reception module, stored in memory, that receives, by a server, a request from an application programming interface (API) to display a web page for a client device;
an initiation module, stored in memory, that initiates, by the server, a page hydration process based on page structure data from the request;
a determination module, stored in memory, that determines, by the server, hydration data to display on the web page based on a contextual analysis of the page structure data;
a collection module, stored in memory, that collects, by the server, the hydration data from a list of data services;
a completion module, stored in memory, that completes, by the server, the page hydration process using the hydration data; and
at least one processor that executes the reception module, the initiation module, the determination module, the collection module, and the completion module.

18. The system of claim 17, wherein the initiation module further performs a warming process to initiate the determination module and the collection module prior to initiating the page hydration process.

19. The system of claim 18, wherein:
the collection module:
collects initial hydration data during the warming process; and
caches the initial hydration data; and
the completion module completes the page hydration process by selecting from the cached initial hydration data, based on the determination module determining the hydration data to display, to hydrate the web page.

20. A non-transitory computer-readable medium comprising one or more computer-executable instructions that, when executed by at least one processor of a computing device, cause the computing device to:
receive, by a server, a request from an application programming interface (API) to display a web page for a client device;
initiate, by the server, a page hydration process based on page structure data from the request;
determine, by the server, hydration data to display on the web page based on a contextual analysis of the page structure data;
collect, by the server, the hydration data from a list of data services; and
complete, by the server, the page hydration process using the hydration data.
